(19) United States
(12) Patent Application Publication
(10) Pub. No.: US 2026/0341739 A1
(43) Pub. Date: Oct. 29, 2026

(54) COMPOSITE CURRENT COLLECTOR

(71) Applicant: Accurate Atom, Inc., DeKalb, IL (US)

(72) Inventors: Tao Xu, Naperville, IL (US); Jason Jiheng Xu, Naperville, IL (US)

(21) Appl. No.: 19/655,222

(22) Filed: Apr. 22, 2026

Related U.S. Application Data
(60) Provisional application No. 63/792,949, filed on Apr. 23, 2025.

(51) Int. Cl. H01M 4/66; H01M 4/02; H01M 50/534; H01M 50/536

(52) U.S. Cl. CPC H01M 4/667; H01M 4/661; H01M 50/534; H01M 50/536; H01M 2004/021

(57) ABSTRACT

Current collectors having a polymeric core layer, intermediate layers, and conductive metal outer layers. Further, methods for preparing current collectors having a polymeric core layer, intermediate layers, and conductive metal outer layers. Additionally, methods for attachment of an electrical connector to a current collector, where the method of attachment of the electrical connector to the current collector achieves an adhesion strength of about 10 N/cm² or greater.

### FIELD

The present disclosure is directed to current collectors having a polymeric core layer, intermediate layers, and conductive metal outer layers. The disclosure is further directed to methods for preparing current collectors having a polymeric core layer, intermediate layers, and conductive metal outer layers. Additionally, methods for attachment of an electrical connector to a current collector are described.

### BACKGROUND

Current collectors for lithium batteries are typically made from conductive metal foil, onto which the cathode and anode are laminated. For example, the cathode may comprise aluminum foil as a conductive substrate and the anode may comprise copper foil as a conductive substrate.

The use of copper metal in current collectors presently accounts for up to 9% of battery mass and around 8-10% in total battery cost.

Therefore, a need exists for new and improved current collectors which comprise a lower total amount of copper.

Previous attempts at reducing the copper foil thickness in a current collector has been constrained by the minimum tensile strength for the copper foil that is acceptable for battery applications.

Therefore, a further need exists for new and improved current collectors which comprise a lower total amount of copper and exhibit improved overall strength despite the lower copper concentration.

### BRIEF SUMMARY

One aspect of the present disclosure is directed to a current collector. The current collector comprises a polymeric core layer; intermediate layers, wherein the intermediate layers are directly on oppositely-disposed surfaces of the core layer and wherein each intermediate layer has a front surface attached to the core layer and an oppositely-disposed back surface; and conductive metal outer layers, wherein the outer layers are directly on each back surface of the intermediate layers.

A further aspect of the present disclosure is directed to a method for preparing a current collector. The method comprises providing a polymeric core layer, wherein the polymeric core layer has oppositely-disposed first and second surfaces; depositing intermediate layers on the first and second surfaces of the polymeric core layer, wherein each intermediate layer has a front surface attached to the first and/or second surface of the core layer and an oppositely-disposed back surface; and depositing conductive metal outer layers directly on each back surface of the intermediate layers.

An additional aspect of the present disclosure is directed to a method for attaching an electrical connector to a current collector. The method comprises placing the electrical connector on at least a portion of the current collector; and applying pressure and an elevated temperature to attach the electrical connector to the current collector. The method is conducted a temperature of from about 75 °C to about 200 °C and the applied pressure is from about 5 psi to about 75 psi.

Other objects and features will be in part apparent and in part pointed out hereinafter.

### BRIEF DESCRIPTION OF THE SEVERAL VIEWS OF THE DRAWING

FIG. 1 illustrates one exemplary embodiment of a current collector of the present disclosure.

FIG. 2 is a Sn—Cu phase diagram.

FIG. 3 is an In—Cu phase diagram.

FIG. 4 is a Bi—Cu phase diagram.

FIG. 5 is a Pb—Cu phase diagram.

FIG. 6 is an Al—Cu phase diagram.

FIGS. 7A-7C show a process for preparing a cylindrical current collector having a shingle configuration.

FIG. 8 shows a current collector prepared according to Example 1.

FIG. 9A shows the result of a peeling test of Example 2 for a Cu/Sn/PET current collector.

FIG. 9B shows the result of a peeling test of Example 2 for a Cu/PET current collector.

FIG. 10A shows the result of a screwdriver puncture test of Example 3 for a Cu/Sn/PET current collector.

FIG. 10B shows the result of a screwdriver puncture test of Example 3 for a Cu/PET current collector.

FIG. 11 shows a burnt Cu/Sn/PET current collector in accordance with Example 4.

FIG. 12A shows the conductivity testing of a burnt Cu/Sn/PET current collector.

FIG. 12B shows the conductivity testing of a burnt Cu/PET current collector.

FIG. 13 shows the experimental design of Example 5.

FIG. 14 reports the results of the testing of Example 5.

FIG. 15 is a diagram showing a method of attachment comprising the use of metal powder.

FIG. 16 shows the testing protocol of Example 6.

FIG. 17 shows the results of the protocol of FIG. 16

FIG. 18 shows the testing protocol of a further experiment of Example 6.

FIG. 19 shows the results of the protocol of FIG. 18.

FIG. 20 reports the voltage profiles recorded during the formation process of Example 7.

FIG. 21 reports the voltage profiles obtained during the HPPC testing protocol of Example 7.

Corresponding reference characters indicate corresponding parts throughout the drawings.

### DETAILED DESCRIPTION

Certain aspects of the present disclosure are directed to current collectors and methods for forming current collectors. The current collectors, in certain embodiments, comprise a polymeric core layer; intermediate layers, wherein the intermediate layers are directly on oppositely-disposed surfaces of the core layer and wherein each intermediate layer has a front surface attached to the core layer and an oppositely-disposed back surface; and conductive metal outer layers, wherein the outer layers are directly on each back surface of the intermediate layers.

Current collectors in lithium batteries are typically made from a conductive metal foil on which the cathode and anode materials are laminated. For example, aluminum foil is used as a conductive substrate for the cathode materials and copper foil is used as a conductive substrate for the anode materials.

The thickness of copper metal foil in current collectors has typically ranged from 6 micron (μm) to 12 μm, depending on battery applications and process requirements. The use of copper metal as a current collector has generally accounted for up to 9% of the battery mass and around 8-10% in total battery materials cost. Copper is rather heavy (density=8.9 g/cm³) and expensive, particularly as the demand for copper increases with the increasing demand in electrical vehicles (EV). The industry has attempted to reduce the thickness of the copper foil in order to reduce both the battery weight and manufacture cost. However, the ability to reduce the thickness of the copper foil is limited. Particularly, the thickness is constrained by the minimum tensile strength required for copper foil to be adaptable for battery applications. That is, too thin of a copper foil may reduce the overall cost, but result in a battery with low durability/longevity.

he inventors have discovered certain configurations, methods, and current collectors that surprisingly allow for a reduction in the total amount of copper required, while simultaneously producing a commercially acceptable product (i.e. that would be adaptable to use in a battery with sufficient durability/longevity).

In one aspect the current collector comprises a polymeric core layer, intermediate layers on either side of the core layer, and conductive metal outer layers still further on the intermediate layers present on both sides.

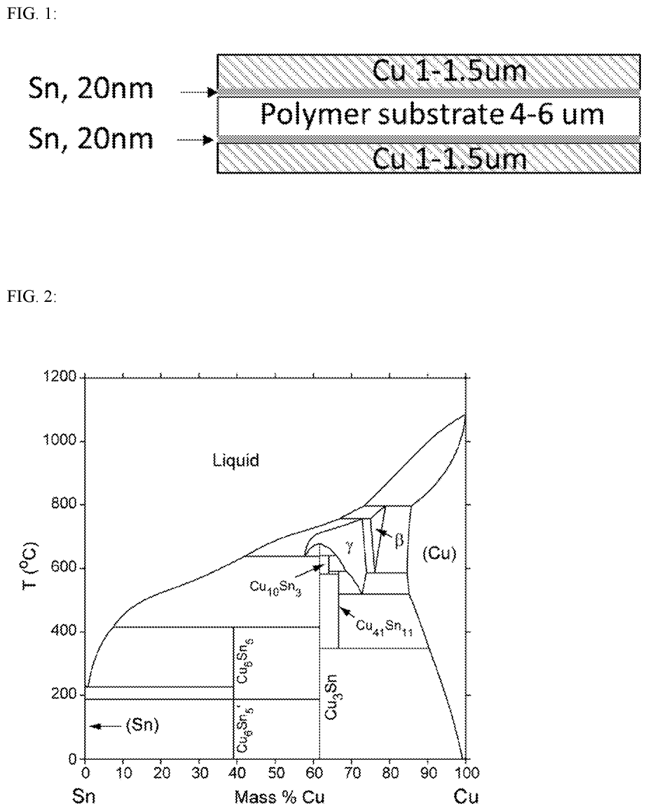

Certain embodiments are directed to a sandwich structure. One exemplary embodiment of such a current collector is shown in FIG. 1. As shown in FIG. 1, a polymer substrate (i.e. polymeric core layer) is present in the middle of the current collector. On the top and bottom of the polymer substrate, tin layers (i.e. intermediate layer) are present. Still further, on top of each tin layer is a copper layer (i.e. conductive metal outer layers). The three-layer sandwich structure of FIG. 1 also specifies certain exemplary thicknesses of each layer. For example, the top and bottom conductive metal outer layers are both copper film with 1-1.5 μm thickness, the top and bottom intermediate layers are both tin with a ~20 nm thickness, and the polymeric core layer is a thin polymer film with an ~4-6 μm thickness.

In other embodiments, the current collector is a sandwich structure comprising: the polymeric core layer, wherein the polymeric core layer has oppositely-disposed first and second surfaces; two intermediate layers, wherein the front surface of the first intermediate layer is directly on the first surface of the polymeric core layer and the front surface of the second intermediate layer directly on the second surface of the polymeric core layer; and two conductive metal outer layers, wherein the first conductive metal outer layer is on the back surface of the first intermediate layer and the second conductive metal outer layer is on the back surface of the second intermediate layer.

The polymeric core layer may be comprised of any suitable material for a current collector. It will be understood that the selection of a suitable polymeric core layer material may depend on a number of factors, such as cost, durability, ability to withstand operating conditions (e.g., temperature) of the battery during operation, etc.

In certain embodiments, the polymeric core layer is selected from the group consisting of polyimide (PI), polyethylene terephthalate (PET), polypropylene (PP), polyphenylene sulfide (PPS), polyethylene naphthalate (PEN), or combinations thereof. In some embodiments, the polymeric core material is PET.

In some embodiments, the polymeric core layer comprises a smallest dimension of from about 1 μm to about 50 μm, from about 1 μm to about 25 μm, from about 1 μm to about 20 μm, from about 1 μm to about 15 μm, from about 1 μm to about 10 μm, from about 2 μm to about 10 μm, from about 3 μm to about 10 μm, from about 4 μm to about 10 μm, from about 4 μm to about 9 μm, from about 4 μm to about 8 μm, from about 4 μm to about 7 μm, or from about 4 μm to about 6 μm. In other embodiments, the polymeric core layer comprises a thickness of from about 1 μm to about 50 μm, from about 1 μm to about 25 μm, from about 1 μm to about 20 μm, from about 1 μm to about 15 μm, from about 1 μm to about 10 μm, from about 2 μm to about 10 μm, from about 3 μm to about 10 μm, from about 4 μm to about 10 μm, from about 4 μm to about 9 μm, from about 4 μm to about 8 μm, from about 4 μm to about 7 μm, or from about 4 μm to about 6 μm.

The intermediate layer may comprise any material that is suitable for placement between the polymer substrate and conductive metal outer layers. For example, in certain embodiments, the intermediate layer materials are selected such that they adequately bond or form a link with both the polymeric substrate and conductive metal (e.g., copper) of the outer layer.

The inventors have discovered problems in previous configurations, due to the weak bonding between copper and polymers. The outer shell valence electrons of copper are mainly in the 3d-4s hybridized orbitals, while the outer shell valence electrons of organic polymers are in 1s-2p hybridized orbitals. In terms of orbital symmetry, i.e. the angular momentum quantum number of electron wavefunctions, both s and d orbitals are symmetric orbitals, while p orbitals are asymmetric orbital.

Most current collector presently available have surface defects due to poor bonding strength between copper layers and polymeric substrate. These defects lead to poor conductivity performance and peeling of copper films during the charge-discharge life cycles. The remedial approach is to use organic-based binder to strengthen the bonding strength between copper layers and the polymer substrate. However, this extra step complicates and raise the cost of the production process. Additionally, the organic-based binder contains chemically reactive functional groups that may react with electrolyte, and may also be dissolved gradually by the electrolyte solutions, particularly under electrochemical conditions, resulting the degradation of bonding performance and negatively impacts the battery performances. Therefore, minimizing/eliminating copper peeling is a key challenge in improving the quality and cost performance of current collectors.

The inventors determined that there must be a metal with p-orbital components in its outer shell electron wave to enhance the bonding between copper and polymer. Therefore, the inventors determined that suitable p-orbital containing metals useful for bonding copper and a polymer may include Al, Ga, Ge, In, Sn, Sb, Tl, Pb, and Bi (excluding radioactive p-orbital metals).

In certain embodiments, the intermediate layers comprise an element selected from the group consisting of Al, Ga, Ge, In, Sn, Sb, Tl, Pb, Bi, or combinations thereof. In one embodiment, the intermediate layers comprise Sn.

Ga, Ge and In are expensive and dispersive elements. Sb is a rare, expensive strategic metal. Tl and Pb are toxic and heavy metal. Bi is also a heavy metal. Al is subject to oxidation and the resulting aluminum oxide is a strong insulator. Particularly when the intermediate layer is thin, the oxide layer can take up a large portion of the intermediate layer, leading to the loss of conductivity of the film. Sn is a widely used metal in almost all solders. Sn metal is considered oxidation tolerant, meaning it resists oxidation (rusting) relatively well due to the formation of a thin protective oxide layer on its surface when exposed to air, which acts as a barrier against further oxidation. Unlike aluminum oxide which is a strong insulator, a tin oxide layer is conductive, and has been used as a component in transparent conducting oxide (TCO) on glass for applications of solar cells and organic light-emitting diodes where both conductivity and transparency are simultaneously required.

It will be understood that any of the described metals may be suitable for use in the intermediate layer in certain embodiments, but not suitable in others. Although discussion herein is primarily directed to Sn, this is not intended to indicate that the other described metals are any less desirable.

Studies were conducted to compare each of these metals for their interaction with copper. Certain aspects of the present disclosure are related to the use of the intermediate layers between (i.e. as a linker) the polymeric core layer and the conductive metal oxide layers (e.g., copper-containing). Therefore, it is important to evaluate the interaction between the proposed intermediate layer metals and copper, to determine whether they present an improvement over the undesirable properties exhibited between copper and polymeric materials.

Phase diagrams of Cu—X were prepared, which resulted in identification of suitable intermediate layer materials capable of strong bonding with copper layer to enhance interfacial adhesion between copper and the intermediate layer's metal X.

X is a metal that can form liquid mixture with Cu at relatively low temperature (<400 °C). This temperature is selected because it is less than the temperature from the kinetic energy given by E=KT/2 of the Cu atoms when falling on the adhesive metal layer, where k is Boltzmann constant and T is temperature in Kelvin. In the case of sputter or vacuum thermal evaporation, the initial kinetic energy of Cu from the source can be estimated by E=kTₘ/2, where Tₘ is the melting point of Cu (Tₘ=1358K). However, after inelastic collision with gas molecules (assuming N₂) in the vacuum (assuming 10-4 torr and gas temperature=350K), the mean free path of a Cu atom in such a low gas pressure is about 50 cm. Assuming the distance between Cu source and the substrate is 50 cm, a Cu atom will encounter at least 1 collision with N₂ molecules.

Assuming energy loss of each collision is 50%, the kinetic temperature of Cu atom will be at least 400 °C when falling on the Sn, sufficient to form a liquid phase at the Sn—Cu interface (note that the interface is only a few atoms thick). As such, at the moment when Cu atoms/plasma fall on the Sn, the Sn—Cu interface is essentially liquid that facilitates the mutual intercalation of the two metals to form strong bonding at the Sn—Cu interface. FIG. 2 presents a Sn—Cu phase diagram, showing that, in the Sn rich area (left side), the Sn—Cu forms liquid at about 220 °C. This suggests an excellent intercalation at the Sn—Cu interface for strong bonding.

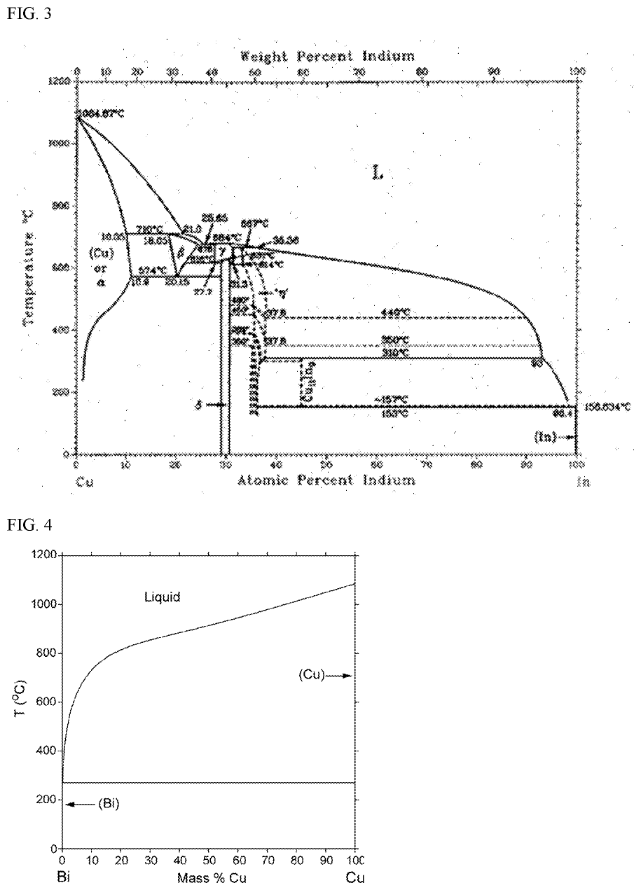

FIG. 3 presents a Cu—In phase diagram, showing that, in the In rich area (right side), the In—Cu forms liquid at about 156 °C. This suggests an excellent liquification intercalation at the Cu—In interface for strong metal-metal bonding.

FIG. 4 presents a Bi—Cu phase diagram, showing that, in the Bi rich zone (left side), the Bi—Cu forms liquid at about 220 °C. This suggests an excellent intercalation at the Bi—Cu interface for strong bonding.

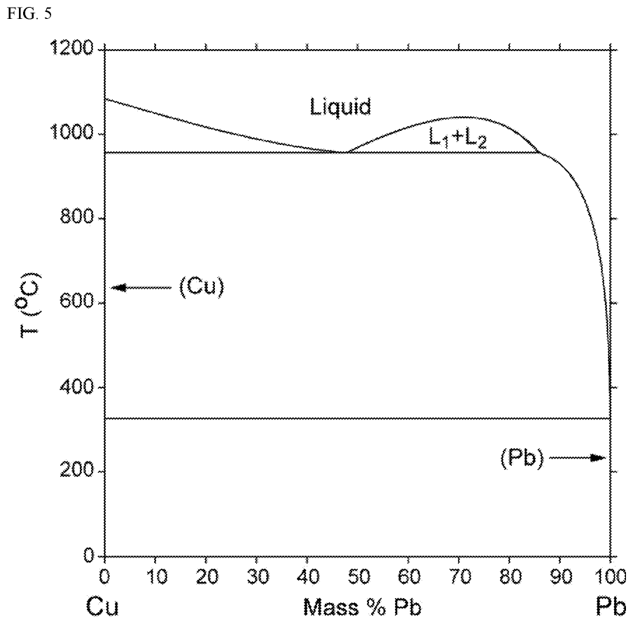

FIG. 5 presents a Cu—Pb phase diagram, showing that, in the Pb rich zone (right side), the Cu—Pb forms liquid at above 400 °C. This suggests that it requires higher temperatures for intercalation at the Cu—Pb interface for strong bonding.

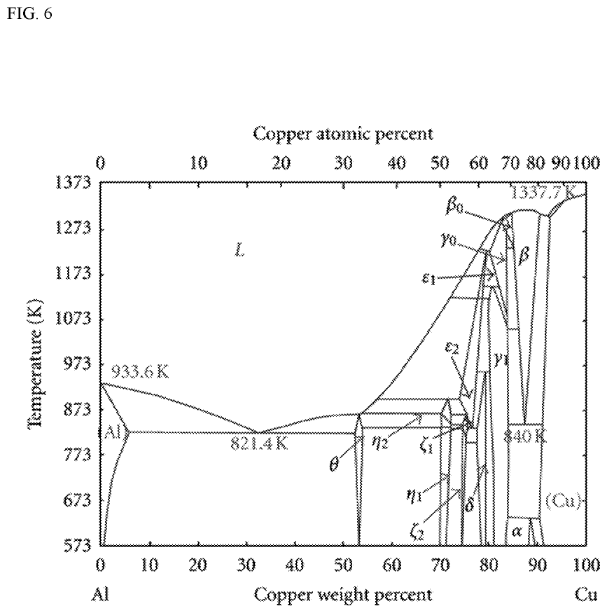

FIG. 6 presents an Al—Cu phase diagram, showing that, in the Al rich zone (left side), the Al—Cu forms liquid at above 600 °C. This also suggests that it requires higher temperature for intercalation at the Al—Cu interface for strong bonding.

In certain embodiments, the metal of the intermediate layer is selected such that it forms a liquid with the metal of the conductive metal outer layers (e.g., Cu) at a temperature of about 500 °C or lower, about 400 °C or lower, about 300 °C or lower, about 200 °C or lower, or about 100 °C or lower.

The intermediate layers, in certain embodiments, observe the “minimum necessary rule” to leave the majority of the thickness of the current collector to the conductive metal outer layer to achieve maximal conductivity within the given total thickness window for metal layers. This is particularly true when the conductive metal outer layer comprises copper (the second most conductive metal). Too thick of intermediate layers will otherwise occupy the volume that could be allocated to the cathode materials for greater battery capacity.

In various embodiments, each intermediate layer comprises a smallest dimension of from about 1 nm to about 500 nm, from about 1 nm to about 450 nm, from about 1 nm to about 400 nm, from about 1 nm to about 350 nm, from about 1 nm to about 300 nm, from about 1 nm to about 250 nm, from about 1 nm to about 200 nm, from about 2 nm to about 200 nm, from about 3 nm to about 200 nm, from about 4 nm to about 200 nm, from about 5 nm to about 200 nm, from about 5 nm to about 175 nm, from about 5 nm to about 150 nm, from about 5 nm to about 125 nm, from about 5 nm to about 100 nm, from about 5 nm to about 75 nm, from about 6 nm to about 75 nm, from about 7 nm to about 75 nm, from about 8 nm to about 75 nm, from about 9 nm to about 75 nm, from about 10 nm to about 75 nm, from about 10 nm to about 70 nm, from about 10 nm to about 65 nm, from about 10 nm to about 60 nm, from about 10 nm to about 55 nm, from about 10 nm to about 50 nm, from about 10 nm to about 40 nm, or from about 10 nm to about 30 nm. For example, each intermediate layer may comprise a thickness of from about 1 nm to about 500 nm, from about 1 nm to about 450 nm, from about 1 nm to about 400 nm, from about 1 nm to about 350 nm, from about 1 nm to about 300 nm, from about 1 nm to about 250 nm, from about 1 nm to about 200 nm, from about 2 nm to about 200 nm, from about 3 nm to about 200 nm, from about 4 nm to about 200 nm, from about 5 nm to about 200 nm, from about 5 nm to about 175 nm, from about 5 nm to about 150 nm, from about 5 nm to about 125 nm, from about 5 nm to about 100 nm, from about 5 nm to about 75 nm, from about 6 nm to about 75 nm, from about 7 nm to about 75 nm, from about 8 nm to about 75 nm, from about 9 nm to about 75 nm, from about 10 nm to about 75 nm, from about 10 nm to about 70 nm, from about 10 nm to about 65 nm, from about 10 nm to about 60 nm, from about 10 nm to about 55 nm, from about 10 nm to about 50 nm, from about 10 nm to about 40 nm, or from about 10 nm to about 30 nm.

The conductive metal outer layers may comprise any conductive metal suitable for use in a current collector (e.g., for use in a battery). In certain embodiments, the conductive metal outer layers comprise Cu, Al, Zn, Sn, or combinations thereof.

In one embodiment, the conductive metal outer layers comprise Cu. Copper does not have alloying issue with lithium (which would otherwise cause expansion and cracking of the lattice of copper) under the anodic electrochemical potential window (0.01~1.5V vs Li+/Li). Therefore, copper may be used in a number of embodiments.

In various embodiments, each conductive metal layer comprises a smallest dimension of from about 0.1 μm to about 5 μm, from about 0.1 μm to about 4 μm, from about 0.1 μm to about 3 μm, from about 0.2 μm to about 3 μm, from about 0.3 μm to about 3 μm, from about 0.4 μm to about 3 μm, from about 0.5 μm to about 3 μm, from about 0.75 μm to about 3 μm, from about 1 μm to about 3 μm, from about 1 μm to about 2.5 μm, from about 1 μm to about 2 μm, or from about 1 μm to about 1.5 μm. For example, a thickness of from about 0.1 μm to about 5 μm, from about 0.1 μm to about 4 μm, from about 0.1 μm to about 3 μm, from about 0.2 μm to about 3 μm, from about 0.3 μm to about 3 μm, from about 0.4 μm to about 3 μm, from about 0.5 μm to about 3 μm, from about 0.75 μm to about 3 μm, from about 1 μm to about 3 μm, from about 1 μm to about 2.5 μm, from about 1 μm to about 2 μm, or from about 1 μm to about 1.5 μm.

In still further embodiments, the conductive metal outer layers have an average roughness (Ra) of about 1 μm or less, about 0.9 μm or less, about 0.8 μm or less, about 0.7 μm or less, about 0.6 μm or less, about 0.5 μm or less, about 0.4 μm or less, about 0.3 μm or less, about 0.2 μm or less, about 0.1 μm or less, about 0.05 μm or less, about 0.025 μm or less, or about 0.01 μm or less.

In various embodiments, the current collector of the present disclosure has a sheet resistance of about 150 mΩ/sq. or less, about 100 mΩ/sq. or less, about 75 mΩ/sq. or less, about 50 mΩ/sq. or less, about 45 mΩ/sq. or less, about 40 mΩ/sq. or less, about 35 mΩ/sq. or less, about 30 mΩ/sq. or less, about 25 mΩ/sq. or less, about 20 mΩ/sq. or less, about 15 mΩ/sq. or less, about 10 mΩ/sq. or less, or about 5 mΩ/sq. or less.

Certain embodiments of the present disclosure are further directed to methods of preparing the described current collector.

For example, in one embodiments, a method for preparing a current collector comprises: providing a polymeric core layer, wherein the polymeric core layer has oppositely-disposed first and second surfaces; depositing intermediate layers on the first and second surfaces of the polymeric core layer, wherein each intermediate layer has a front surface attached to the first and/or second surface of the core layer and an oppositely-disposed back surface; and depositing conductive metal outer layers directly on each back surface of the intermediate layers.

In various embodiments, depositing the intermediate layers and/or depositing the conductive metal outer layers comprises dry physical vapor deposition, wet chemistry-based electrochemical deposition, or combinations thereof. Physical vapor deposition may generally include sputter deposition or thermal vapor evaporation.

In some embodiments, depositing the intermediate layers comprises a thermal evaporation process, sputter deposition, pulsed laser deposition, e-beam deposition, electrochemical deposition, or combinations thereof.

In other embodiments, depositing the conductive metal outer layers comprises a thermal evaporation process, sputter deposition, pulsed laser deposition, e-beam deposition, electrochemical deposition, or combinations thereof.

In still further embodiments, the method comprises depositing the intermediate layers and depositing the conductive metal outer layers using a roll-to-roll sputtering deposition process or roll-to-roll vacuum coating process.

Although certain specific deposition techniques are described, it will be understood that the present disclosure may encompass a combination of methods. For example, a combination of both dry and wet coating methods.

There may be a risk of mechanical failure or macroscopic rupture of the thin polymer substrate during the high-tension environment of certain deposition techniques, such as roll-to-roll physical vapor deposition (PVD) or sputtering processes. To attempt to mitigate this risk, in certain embodiments, the thin polymer substrate may be initially provided as a laminated composite comprising a supporting secondary polymer layer of greater cross-sectional thickness. That is, the polymer substrate may initially have further supporting layers on one or more sides of the substrate to increase the integrity of the polymer substrate.

In one embodiment, a polymer substrate is provided with a support layer on a first surface of the polymer substrate. A first intermediate layer and first conductive metal outer layer are then deposited on a second surface of the polymer substrate (e.g., as discussed in further detail herein), opposite of the side in which the support layer is present. In a next step, the support layer is removed from the polymer substrate. A second intermediate layer and second conductive metal outer layer are then deposited on the now-exposed first surface of the polymer substrate (e.g., as discussed in further detail herein). This process is believed to ensure that the thin polymer core remains below its tensile yield point throughout the thermal and mechanical stresses of the metal outer layer application processes. This allows for the resulting current collector to maintain the dimensional stability required for high-performance battery applications.

In various embodiments, the support layer has a greater thickness than the polymer substrate. In other embodiments, the thickness of the support layer and the thickness of the polymer substrate are about equal. In another embodiment, the polymer substrate is thicker than the support layer. For example, the support layer may have a cross-sectional area greater than, about equal to, or smaller than the cross-sectional area of the polymer substrate (i.e. as measured at the same cross-section wherein the support layer is present on a surface of the polymer substrate).

In certain embodiments, the support layer comprises a polymeric material. In one embodiment, the polymeric material of the support layer is different from the polymeric material of the polymer substrate. In another embodiment, the polymeric material of the support layer is the same as the polymeric material of the polymer substrate. In still further embodiment, the support layer does not comprise polymeric material. It will be understood that the support layer material may comprise any material that is suitable for application to the polymer substrate, but which is amenable to being removed from the polymer substrate at the necessary point in the process.

In one embodiment, the support layer is attached to the polymer substrate via a lamination process. In another embodiment, the support layer is attached to the polymer substrate via a roll-to-roll process. It will be understood that the exact method of application to the polymer substrate will depend on the specific materials of the support layer and the polymer substrate. Nevertheless, in various embodiments, the support layer should be applied in a manner that allows for the support layer to be subsequently removed.

In one embodiment, the support layer is removed from the polymer substrate via a delamination process. In another embodiment, the support layer is removed by a roll-to-roll process (e.g., wherein the support layer is rewound). It will be understood that the exact method of removing the polymer substrate will depend on the specific materials of the support layer and the polymer substrate. Nevertheless, in various embodiments, a removal method should be employed which removes substantially all of the support layer, thereby exposing the first surface of the polymer substrate for subsequent application of an intermediate layer and conductive metal outer layer.

In one embodiment, magnetron sputtering is used as the seeding conductive layer, followed by electrochemical water plating. In another embodiment, magnetron sputtering and evaporation plating are used as the conductive seeding layer, following by water plating. In still further embodiments, the deposition may be completely by magnetron sputtering or evaporation plating, without using electrochemical water plating.

In various embodiments, magnetron sputtering produces the best quality Cu layer, while electrochemical water plate is a cheaper but lower-quality process.

In certain configurations an electrical connector (e.g., battery tab), typically made of aluminum or nickel, connects the positive and negative electrodes (i.e. current collectors) inside a battery cell to the outside circuit, enabling the flow of electricity.

The dominate industrial attachment method between the battery tab and current collectors is ultrasonic or laser welding, or ultrasound soldering. However, due to the soft nature of the polymeric core layer and the limited thickness of the conductive metal outer layers described herein, it is very difficult to weld a battery tab with the current collector using these welding methods. For example, the polymeric core layer may be subject to melting at traditional welding temperatures and the thickness of the conductive metal outer layers on the current collectors may not be thick enough for welding. Attempts at welding this configuration would create so-called “pseudo soldering” between the current collector and the battery tab. The resulting products would not be robust enough for durable performance. The pseudo soldering phenomenon would also drastically increase the internal resistance of the welding junction and eventually lead to overheating during the charging/discharge process.

Therefore, it is important to devise new attachment methods for the current collectors described herein.

Additional aspects of the present disclosure are directed to methods of attaching an electrical connector to a current collector.

Certain commercially available conductive copper foil tapes, that are generally used for a completely different purpose/industry (duct tape or other general electric purpose), have been found to be useful for forming robust electrical connection with the current collector of the present disclosure without a traditional soldering/welding process.

The described methods, in certain embodiments, attach such conductive copper foil tape onto the current collector of the present disclosure in order to achieve sufficient bonding strength and low electrical resistance at the current collector-copper foil tape junction.

In one embodiment, the method comprises placing the electrical connector on at least a portion of the current collector and applying pressure and an elevated temperature to attach the electrical connector to the current collector.

The electrical connector may be any material suitable for connecting a current collector to other desired systems or components. For example, an electrical connector suitable for connecting a current collector to a battery charging system.

In some embodiments, the electrical connector comprises aluminum, nickel, copper, tin, zinc, or combinations thereof. In other embodiments, the electrical connector is a conductive copper foil tape. For example, conductive copper foil tape commercially available from 3M Company.

In one embodiment, the electrical connector may comprise an adhesive on one or more surface of the electrical connector. For example, a copper conductive adhesive shielding tape commercially available from 3M Company.

The current collector may be any current collector. In certain embodiments, the current collector is one or more of the current collectors described herein. For example, the sandwich structure current collector illustrated in FIG. 1.

In various embodiments the elevated temperature of the attachment method may be from about 75 °C to about 200 °C, from about 75 °C to about 190 °C, from about 75 °C to about 180 °C, from about 75 °C to about 170 °C, from about 75 °C to about 160 °C, from about 75 °C to about 150 °C, from about 80 °C to about 150 °C, from about 85 °C to about 150 °C, from about 90 °C to about 150 °C, from about 95 °C to about 150 °C, from about 100 °C to about 150 °C, from about 100 °C to about 140 °C, from about 100 °C to about 130 °C, or from about 100 °C to about 120 °C. In other embodiments, the elevated temperature of the attachment method may be from about 120 °C to about 140 °C.

In certain embodiments, the pressure utilized during the attachment method may be from about 5 psi to about 75 psi, from about 5 psi to about 50 psi, from about 5 psi to about 45 psi, from about 5 psi to about 40 psi, from about 5 psi to about 35 psi, from about 5 psi to about 30 psi, from about 10 psi to about 30 psi, from about 15 psi to about 30 psi, or from about 20 psi to about 30 psi.

In some embodiments of the method of attachment, the pressure is applied for a period of from about 5 to about 300 seconds, from about 5 to about 250 seconds, from about 5 to about 200 seconds, from about 5 to about 150 seconds, from about 5 to about 100 seconds, from about 10 to about 100 seconds, from about 15 to about 100 seconds, from about 20 to about 100 seconds, from about 20 to about 90 seconds, from about 20 to about 80 seconds, from about 30 to about 80 seconds, or from about 40 to about 80 seconds.

In additional aspects of the method of attachment, the method further comprises placing metal powder between the electrical connector and the current collector prior to applying the pressure at an elevated temperature. The metal powder may comprise metal particles. For example, metal particles selected from the group consisting of copper, silver, tin, indium, zinc or combinations thereof.

In certain embodiments, the metal particles have a size of from about 25 to about 5,000 mesh, from about 25 to about 4,000 mesh, from about 25 to about 3,000 mesh, from about 25 to about 2,000 mesh, from about 25 to about 1,000 mesh, from about 50 to about 1,000 mesh, from about 100 to about 900 mesh, from about 100 to about 800 mesh, from about 100 to about 700 mesh, from about 100 to about 600 mesh, from about 100 to about 500 mesh, from about 200 to about 500 mesh, or from about 300 to about 500 mesh.

In various embodiments wherein the current conductor comprises an adhesive on one or more surface of the electrical connector, the metal particles may be embedded in the adhesive prior to attachment to the current conductor.

In other embodiments, the metal particles are present on the surface of the electrical connector that is placed on at least a portion of the current collector in a concentration of about 20 mg/cm² or less, about 15 mg/cm² or less, about 10 mg/cm² or less, about 5 mg/cm² or less, about 1 mg/cm² or less, about 0.75 mg/cm² or less, about 0.5 mg/cm² or less, or about 0.25 mg/cm² or less.

In one embodiment, a small amount of metal powders (typically copper powder, or silver powder) with size between 50~1000 mesh, preferred 300-500 mesh, is spread onto the stick side of the copper foil tape with <10 mg/cm² to enhance the junction conductivity via these isolated copper powder domains in the case the junction conductivity is less than 10 S/cm².

It will be understood that there is a balance between conductivity and adhesion when utilizing metal powders. Too much metal powder will deteriorate the adhesion between the electrical connector and the current collector. Therefore, in some embodiments, the mass of metal powder added to the electrical connector (e.g., an adhesive present on the electrical connector) is about 0.5 mg/cm².

In various embodiments, the method of attachment of the electrical connector to the current collector achieves an adhesion strength of about 1 N/cm² or greater, about 5 N/cm² or greater, about 10 N/cm² or greater, about 15 N/cm² or greater, about 20 N/cm² or greater, or about 25 N/cm² or greater.

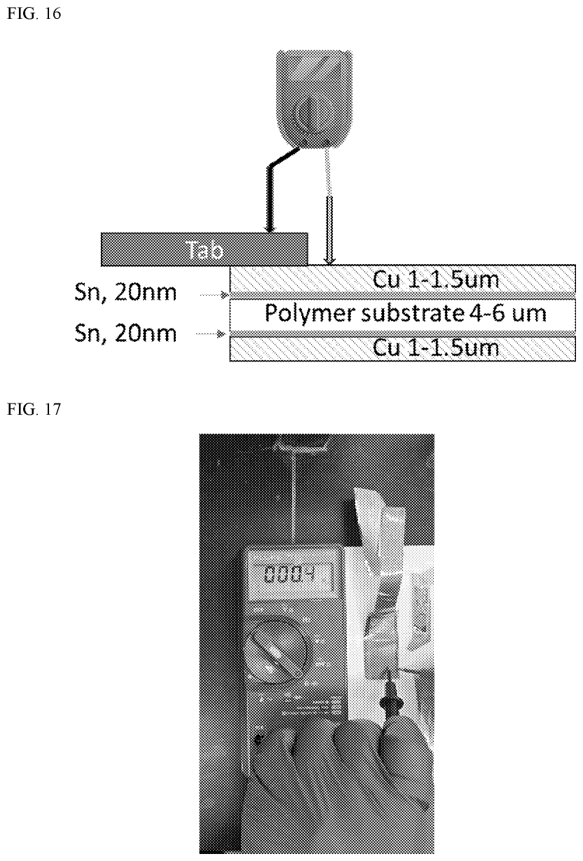

In certain embodiments, with or without metal particles added to the electrical connector, the conductance between the electrical connector and the current collector (e.g., as measured via the procedure illustrated in FIG. 16 and discussed in further detail below) is about 1 S/cm² or greater, about 2 S/cm² or greater, about 3 S/cm² or greater, about 4 S/cm² or greater, about 5 S/cm² or greater, about 6 S/cm² or greater, about 7 S/cm² or greater, about 8 S/cm² or greater, about 9 S/cm² or greater, about 10 S/cm² or greater, about 15 S/cm² or greater, about 20 S/cm² or greater, about 25 S/cm² or greater, about 50 S/cm² or greater, or about 100 S/cm² or greater. For example, from about 1 S/cm² to about 100 S/cm², from about 1 S/cm² to about 50 S/cm², from about 1 S/cm² to about 25 S/cm², from about 1 S/cm² to about 10 S/cm², from about 1 S/cm² to about 9 S/cm², from about 1 S/cm² to about 8 S/cm², from about 1 S/cm² to about 7 S/cm², from about 1 S/cm² to about 6 S/cm², or from about 1 S/cm² to about 5 S/cm².

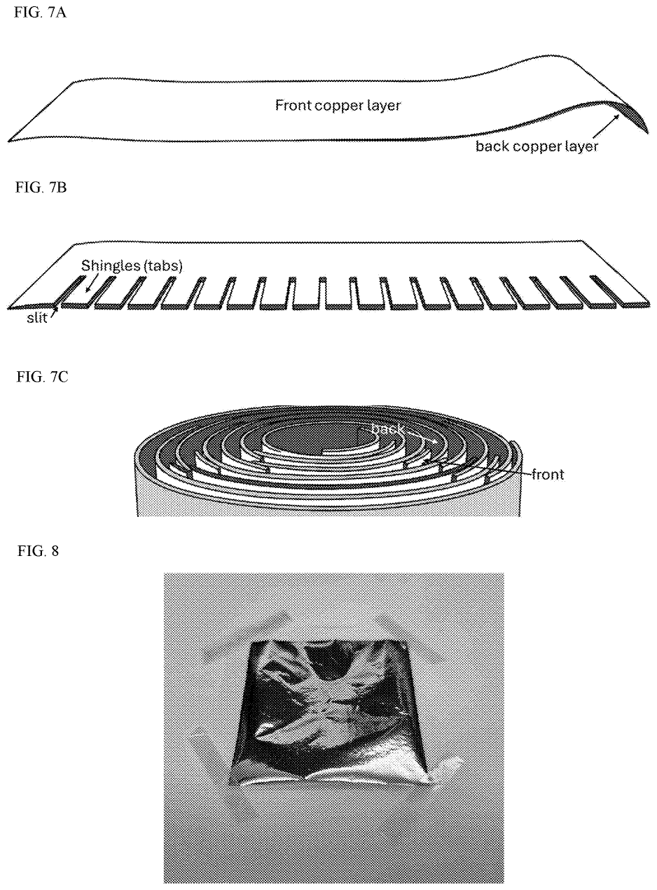

In still further embodiments, the current collector may comprise a shingle configuration. For example, when utilizing the current collector in a cylindrical multilayer battery configuration, the current collector may be configured as shown in FIGS. 7A-7C.

FIG. 7A illustrates a current collector as described herein, comprising a front (outer) copper layer, a back (outer) copper layer, and a polymer substrate core (the intermediate layer(s) are now illustrated).

FIG. 7B illustrates the current collector of FIG. 7A, wherein slits have been cut in one edge of the current collector to form a series of slits and shingles (tabs). The slits and shingles, respectively, may be equidistant from one another or in an irregular pattern. The slits and shingles, respectively, may be of the same width and length or of irregular widths and lengths.

FIG. 7C illustrates the current collector of FIG. 7B rolled into a cylindrical shape.

In case of multilayer battery configuration, such as a cylindrical battery, the spiral shingle tab design (e.g., as illustrated in these figures) allows for the critical electrical interconnection. In certain of these embodiments, the central polymeric substrate layer is an electrical insulator, preventing direct galvanic coupling between the first conductive layer (i.e. front copper layer) and the second conductive layer (i.e. back copper layer). This is represented in FIG. 7C, wherein the first conductive layer is the white surface and the second conductive layer is the dark grey surface.

Upon winding the current collector into a cylindrical shape, as shown in FIG. 7C, the shingles will all be present at one end of the cylindrical shape. Deflecting or pressing these shingles down toward the longitudinal axis of the cylinder (i.e. towards the center) naturally leads to the first conductive surface of one layer of the cylindrical winding to make forced physical contact with the second conductive surface of a preceding winding. Through this iterative spiral contact, the “front” and “back” copper layers, which are otherwise isolated by the polymer core, are electrically bridged at the axial ends of the cell. Consequently, the cylindrical geometry enables current collection from both copper faces simultaneously. This ensures that the insulating polymer core does not impede total current density, thereby facilitating the use of lightweight composite collectors in high-power cylindrical multilayer battery configuration.

One advantage of this configuration is illustrated wherein the current collector has a height less than the length. For example, considering a 10 m long current collector that is 80 mm tall, the current collector can be wound into a compact cylindrical shape. After the shingles are compressed at one end and electrically bridged, the electrons can then travel along the much shorter 80 mm height of the cylinder (as compared to traveling the entire 10 m long distance from one edge of the current collector to the other opposite edge). In another embodiment, for example when used in an electric vehicle battery, the current collector may comprise a 12 μm thick polyimide core with a 1 μm thick copper layer on each side, and be 30 m long and 2 ft. tall. In this case, a cylindrical configuration as described herein will provide significant space savings and allow for a much shorter electron pathway.

Having described the present invention in various embodiments, and in the experimental testing set forth in the Examples below, it will be understood that a number of benefits may be achieved by the described embodiments.

Firstly, enhanced safety performance. Current collectors of the present disclosure, with relatively thinner metal layers (i.e. conductive metal outer layers), minimizes the formation of metal burrs upon mechanical impact thus minimizing the risk of fire caused by internal short-circuit. When experiencing overheating, the polymeric core layer will melt to wrap up the conducting copper layers so as to break up the circuit, impeding cascading electrical shots and fire. For example, the melting point of PET is 260 °C, which is much lower than that of copper 1085 °C.

Additionally, an enhanced cycle life may be observed. Current collectors of the present disclosure can mitigate Li dendrites. Unlike rigid copper foil of previous configurations, the flexible nature of the polymer layer in the current collectors of the present disclosure allow the substrate to accommodate some strain and stress from the anode layer during charging and discharge, providing more smoothed solid-electrolyte interface (SEI) layer and less lithium dendrites. Consequently, current collectors of the present disclosure also exhibit improvements in coulombic efficiency.

The current collectors of the present disclosure may further have a reduced anode weight. For example, a reduction in anode weight by 57%, leading to a 5.4% weight reduction of total battery weigh or a 5.6% increase in gravimetric energy density of the total battery.

In other embodiments, the described current collector may have a weight of about 60% or less, about 55% or less, about 50% or less, about 45% or less, about 40% or less, about 35% or less, about 30% or less, about 25% or less, about 20% or less, or about 15% or less than that of a similarly sized current collector comprised solely of copper. As such, it is also possible that the described current collectors may have a total copper concentration of about 60% or less, about 55% or less, about 50% or less, about 45% or less, about 40% or less, about 35% or less, about 30% or less, about 25% or less, about 20% or less, or about 15% or less than that of a similarly sized current collector comprised solely of copper.

Still further, it is possible that the current collectors described herein may achieve commercially acceptable results while being at least about 1%, at least about 2%, at least about 3%, at least about 4%, at least about 5%, at least about 10%, or at least about 15% thinner than a current collector comprised solely of copper capable of achieving similar results.

The relatively low cost of the materials used in the current collectors of the present disclosure also make the present embodiments desirable and a significant improvement on previous current collectors and batteries used in the industry.

Although reference may be made herein to a particular configuration or method of preparing a particular configuration of a current collector (e.g., Cu—Sn-Polymer-Sn—Cu), it will be understood that the specific materials and components used in each layer and/or the ordering may be modified as discussed herein.

Further, although reference is made herein to a stacked or sandwich structure having layered configuration, a current collector that is fully encased or surrounded by one or more conductive metal layers is within the scope of the present disclosure. For example, the current collector may comprise one or more additional conductive metal outer layers, such that all outer surfaces of the current collector are comprised of a conductive metal outer layer and none of the polymeric core layer or intermediate layers form an outer surface of the current collector.

Still further, it will be understood that the current collectors described herein may be used in a variety of products. For example, the current collectors may be used in lithium batteries, electric vehicle batteries, electric plane batteries, pouch cell batteries, etc.

Having described the invention in detail, it will be apparent that modifications and variations are possible without departing from the scope of the invention defined in the appended claims.

### EXAMPLES

The following non-limiting examples are provided to further illustrate the present invention.

### Example 1

In a first example, a current collector of one embodiment of the present invention was prepared. The current collector was generally of the configuration illustrated in FIG. 1.

A Sn layer was deposited on a polymer substrate such as PET with thickness of 4~6 μm using either thermal evaporation process or sputter deposition process. The thickness of Sn layer was controlled between 5~200 nm, preferably between 10-50 nm, typically 20 nm. The copper layer was deposited onto the Sn layer via either thermal evaporation process or sputter deposition process with a preferred thickness range of 0.5-2 μm, typically 1.1 μm.

One current collector prepared according to this method, with a polymer substrate thickness of 6 μm, is shown in FIG. 8.

### Example 2

Next, a comparison was done between a current collector of the present disclosure (i.e. Cu/Sn/PET) and a traditional current collector without an intermediate layer (i.e. Cu/PET).

Scotch tape was placed on each of the current collectors, and subsequently peeled off by hand. To ensure that the results provided information about the strength of the tape-Cu interface, a thicker polymeric core layer was used for each current collector (i.e. 0.25 mm PET).

The Cu—Sn-PET exhibited resistance to the peeling by the scotch tape, while the bare Cu on PET was subject to peeling off by the scotch tape.

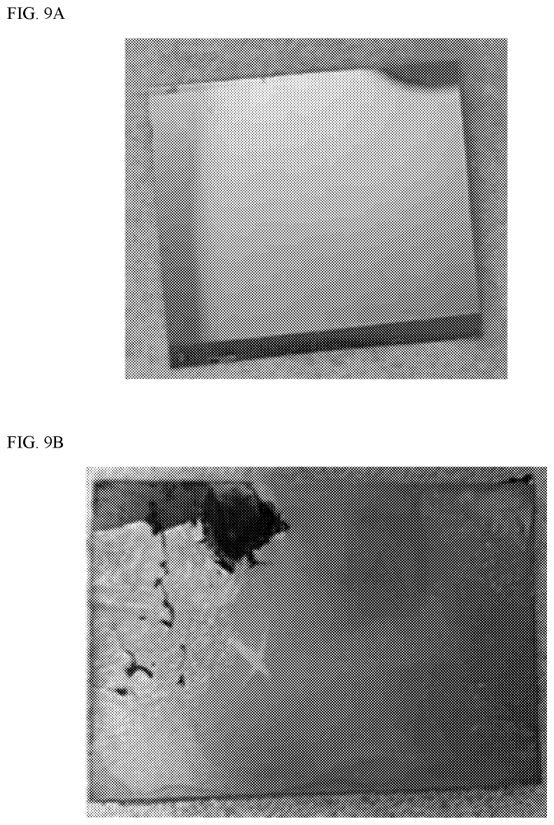

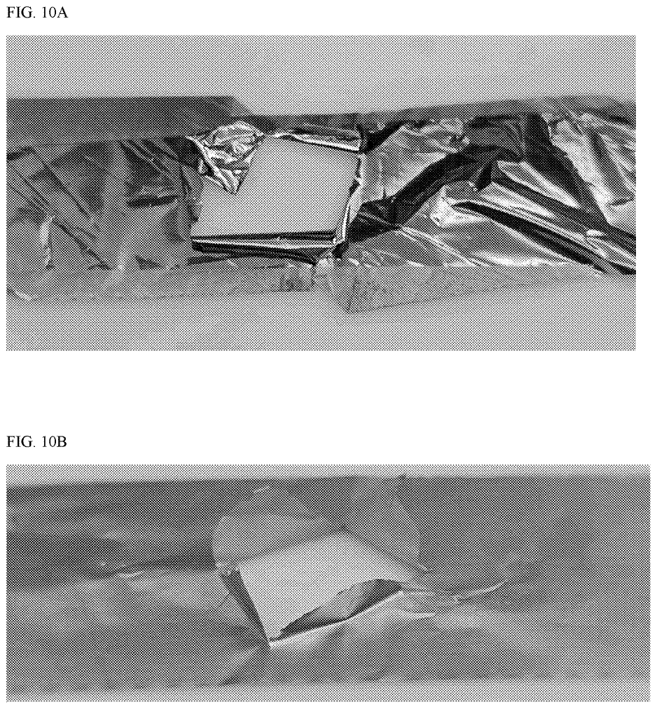

The results are shown in FIG. 9A (Cu/Sn/PET) and FIG. 9B (Cu/PET).

### Example 3

In a further example, the current collectors of Example 2 were tested by poking the current collector with a screwdriver.

The results are shown in FIG. 10A (Cu/Sn/PET) and FIG. 10B (Cu/PET).

It is clear that the traditional current collector (Cu/PET) forms standing burrs, while the burrs of a current collector of the present disclosure (Cu/Sn/PET) curled because the polymer substrate is soft and plastic, thus cannot form standing burrs. This may be valuable in certain contexts, as the Cu/Sn/PET curled burrs do not have the strength to puncture other structures in the battery.

### Example 4

Next, a traditional current collector (Cu/PET) and current collector of the present disclosure (Cu/Sn/PET) were subjected to fire.

After burning, the Cu/Sn/PET current collector curls up into a heap and its point-to-point (1 mm apart) resistance rises to >11 kΩ. The traditional current collector remained flat and a good conductor after burning with point-to-point (1 mm apart) resistance=0.2 (2, 5 orders of magnitude lower than that of the Cu/Sn/PET current collector.

Thus, the Cu/Sn/PET current collector appears poorly conductive upon fire burning. In stark contrast, after fire burning, the traditional current collector is still a good conductor. This feature provides additional safety to minimize the cascading short circuits during thermal failure of the batteries.

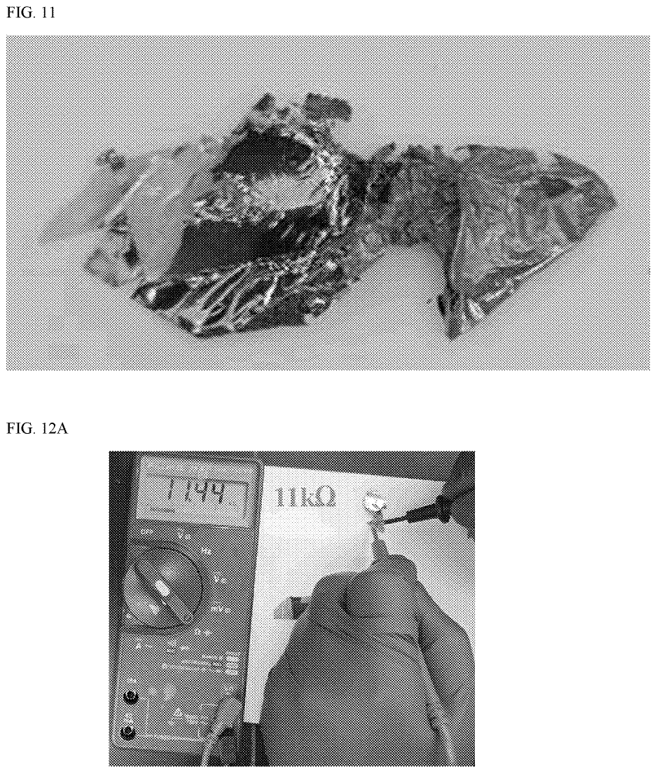

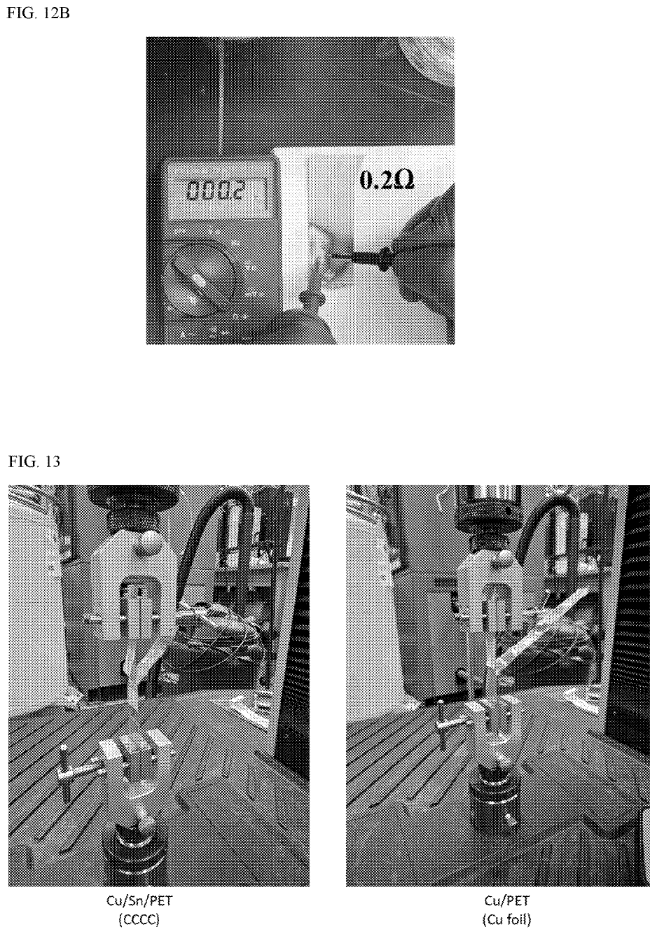

A burnt current collector of the present disclosure (Cu/Sn/PET) is shown in FIG. 11.

FIG. 12A shows the conductivity testing of a burnt Cu/Sn/PET current collector. FIG. 12B shows the conductivity testing of a burnt Cu/PET current collector.

### Example 5

To evaluate the bonding strength between metal and polymer substrate in a current collector of the present disclosure (Cu/Sn/PET), a T-peeling study was conducted by using a sticky copper tape that was adhered to the surface of the current collector.

In a comparative experiment, the same sticky copper tape was adhered to a traditional current collector (Cu/PET).

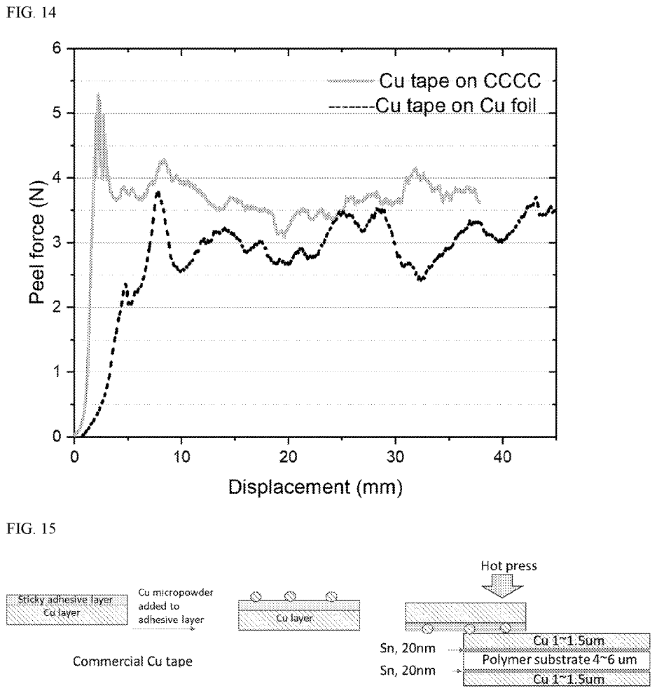

The experimental design is shown in FIG. 13 and the results are reported in FIG. 14.

The result shows that it took up to 5 N to peel the copper foil from the Cu/Sn/PET surface, noting that the Cu layer on the Cu/Sn/PET was not detached. That is, the current collector of the present disclosure was such that peeling a tape from its surface was unable to peel off the Cu or Cu/Sn layer from the polymeric core.

The Cu/Sn/PET current collector exhibited the following technical specifications shown in Table 1.

TABLE 1

| Items | Specifications |
|---|---|
| Polymer Substrate | 4.5 μm, 6 μm |
| thickness | |
| Sn layer thickness | 5~150 nm, typically 20 nm |
| (both sides) | |
| Copper layer thickness | 1~2 μm, typically 1.1 μm physical |
| (both sides) | vapor deposition |
| Copper layer roughness | Roughness average (Ra) <0.1 |
| (μm) | |
| Tensile Strength (Mpa) | 230 lbf./in. (Machine Direction—MD) |
| | 220 lbf./in. (Transverse Direction—TD) |
| Sheet resistance | <30 |
| (mΩ/sq.) | |
| Pinholes | None or <0.01/m², eye inspected |
| Adhesion | No copper layer peeling off by tape |
| Antioxidation | If stored in dry air, no discoloration |

### Example 6

A further experiment was conducted to attach an electrical connector to a current collector of the present disclosure and test the adhesion strength. The method comprised placing a conductive copper foil tape (i.e. electrical connector) on at least a portion of the current collector and applying pressure and an elevated temperature to attached the electrical connector to the current collector.

Alternatively, the method of attachment may comprise the use of metal powder. For example, as shown in FIG. 15. In FIG. 15, dispersed metal powder (represented by the spheres on the adhesive layer aid in forming attachment to the current collector when elevated temperature and pressure are applied.

The applied pressure was between 10-50 psi, with a preferred range of 15-20 psi. The temperature was kept between 80-150 °C, preferred between 100-120 °C. The press time duration was typically between 5-300 seconds, with a preferred range of 40-80 seconds.

After this attachment process, the junction conductance at the Tab-Current Collector interface was measured to be as high as 10 Siemens(S)/cm². The testing protocol is shown at FIG. 16 and the results of the test are shown at FIG. 17. The contact area was 0.25 cm² and the measured resistance is 0.4Ω, or 2.5 Siemens(S). Therefore, the conductance per area is (1/0.4Ω)/0.25 cm²=10 S/cm².

Contact area of a battery tab-current collector of 1 cm² is common for pouch cell batteries. Assuming the charging-discharging current is I=1 A passing through this 1 cm² area junction, which is a high theoretical value, one can compare the Joule heating power P_{J}=I²R (where R is the resistance at the junction, which is 0.1Ω, thus P_{J}=0.1 W) with the heat loss through black-body radiation using Stefan-Boltzmann law. In the general case, the radiant power P_{R} is given by P_{R}=AεσT⁴, where A is surface area (i.e. 2 cm² due to both front and backside for emission), ε is the emissivity of the surface emitting the radiation (0.64 for rolled copper surface), and σ is Stefan-Boltzmann constant equal to 5.67×10⁻⁸ W·m⁻²·K⁻⁴. Assuming 50 °C (323 K) is tolerable for the electrical connector (battery tab), thus P_{R}=0.08 W, which is already 80% of the Joule heating power P_{J}, not counting the heat loss via conduction and air convection. Therefore, this junction resistance is on the low and safe end.

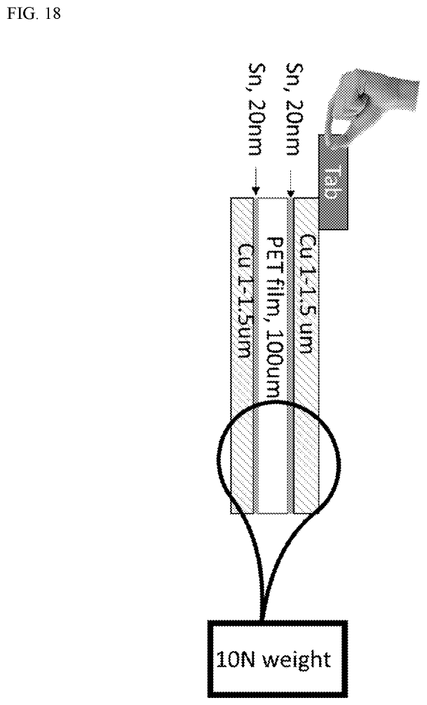

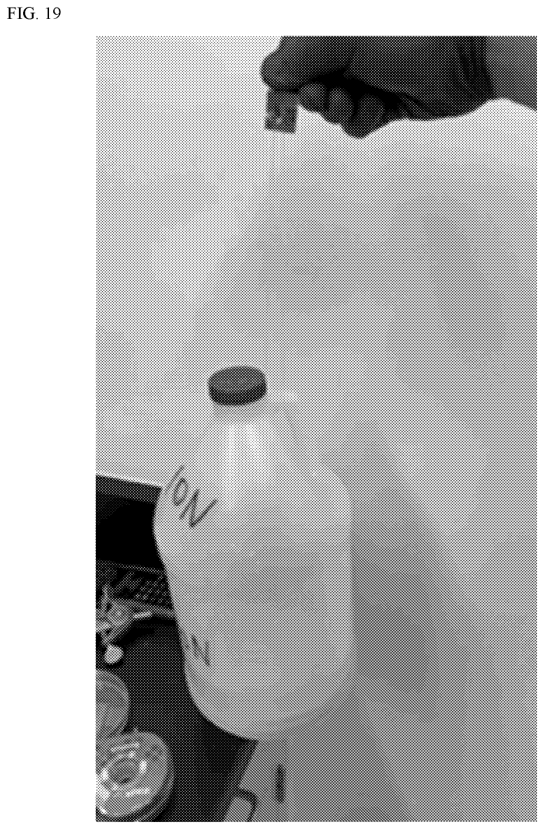

Next, the bond between the electrical connector and the current collector was evaluated. FIG. 18 shows a graph of the testing protocol, and FIG. 19 shows a photograph of the testing.

In this experiment, a polymeric core layer 4 μm thick was used, to ensure the test of the results related to the bonding strength of the electrical connector. The results show that the adhesion with an area of 1 cm² was strong enough to hold 10N for days.

### Example 7

In a further example, the electrochemical performance of a pouch cell incorporating a composite copper current collector of the present disclosure was evaluated.

The pouch cell, in a 043450 format (i.e. 0.4 mm thick, 34 mm wide, 50 mm long), possessed a total capacity of approximately 15 mAh and an electrode area of 14.1 cm². The cathode comprised a LiNiₓMn_{y}Co_{1-x-y}O₂ (NMC) active material coated onto an aluminum (Al) current collector. The anode comprised graphite coated onto the composite copper current collector as described herein. A conventional electrolyte comprising ethylene carbonate (EC) was employed.

The pouch cell was subjected to a predefined formation protocol under controlled temperature conditions. The procedure began with two tap-charge steps at a constant voltage of 1.5 V for 15 minutes each. Following the tap-charge, the cell underwent three formation cycles at a constant current of 1.6 mA within a voltage range of 3.0 V to 3.9 V. This was succeeded by three additional formation cycles at the same current with an extended voltage range of 3.0 V to 4.0 V. That is, the testing protocol was as follows.
1. Tap-1:1.5V, 1.6 mA (15 min)
2. Tap 2:1.5V, 1.6 mA (15 min)
3. Form 1-3:3-3.9V, 1.6 mA (0.8 mA)
4. Form 4-6:3-4.0V, 1.6 mA (0.8 mA)

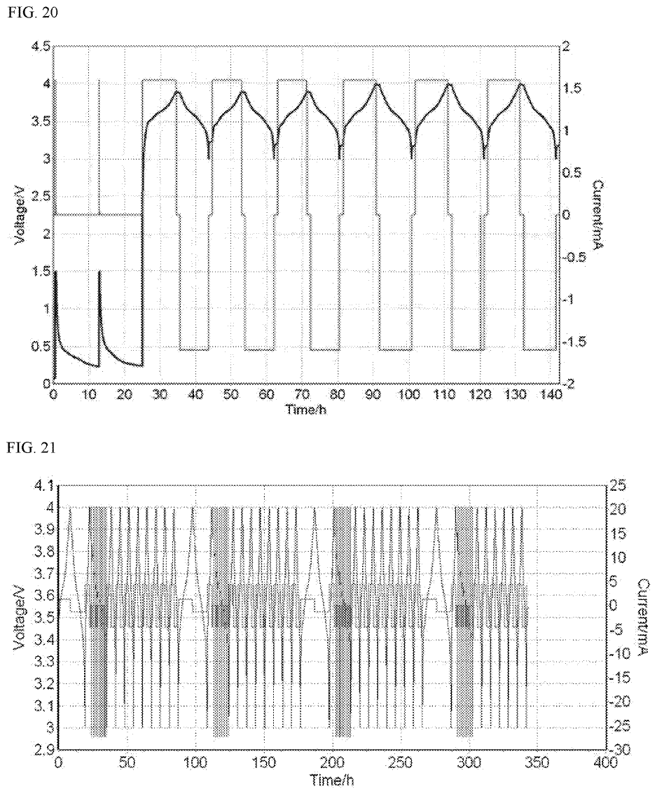

The voltage profiles recorded during the formation process are illustrated in FIG. 20. These results indicated stable charge/discharge behavior, with no evidence of short circuits or significant overpotential.

Following the formation process, the pouch cell was subjected to four hybrid pulse power characterization (HPPC) test cycles to assess the performance of the composite current collector under conditions representative of electric vehicle operation. Each HPPC test cycle comprised the following sequence:
(i) a full charge and discharge at a C/10 rate over the voltage range of 3.0 V to 4.0 V;
(ii) a constant current charge at a C/3 rate to 4.0 V; and
(iii) a discharge at a C/3 rate corresponding to 5% of the cell's state of charge (SOC), followed by a 2 C charge pulse and a 1.5 C discharge pulse, each applied for 10 seconds.

The discharge step (iii) and the corresponding pulse sequence were repeated up to 18 times or until the cell voltage reached 3.0 V, whichever occurred first. Upon completion of the HPPC sequence, the cell was subjected to eight aging cycles consisting of charge and discharge at a C/3 rate between 3.0 V and 4.0 V. This full combination of HPPC testing and subsequent aging cycling completed one HPPC test cycle.

The voltage and current profiles obtained during the HPPC testing protocol are illustrated in FIG. 21. The absence of short-circuit behavior, significant overpotential, or degradation in cell performance confirmed the effectiveness of the composite current collector described herein in maintaining cell integrity under electric vehicle operating conditions.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

1. A current collector, comprising:
a polymeric core layer;
intermediate layers, wherein the intermediate layers are directly on oppositely-disposed surfaces of the core layer and wherein each intermediate layer has a front surface attached to the core layer and an oppositely-disposed back surface; and
conductive metal outer layers, wherein the outer layers are directly on each back surface of the intermediate layers.

2. The current collector of claim 1, wherein the current collector is a sandwich structure comprising:
the polymeric core layer, wherein the polymeric core layer has oppositely-disposed first and second surfaces,
two intermediate layers, wherein the front surface of the first intermediate layer is directly on the first surface of the polymeric core layer and the front surface of the second intermediate layer directly on the second surface of the polymeric core layer; and
two conductive metal outer layers, wherein the first conductive metal outer layer is on the back surface of the first intermediate layer and the second conductive metal outer layer is on the back surface of the second intermediate layer.

3. The current collector of claim 2, wherein the current collector further comprises one or more additional conductive metal outer layers, such that all outer surfaces of the current collector are comprised of a conductive metal outer layer and none of the polymeric core layer or intermediate layers form an outer surface of the current collector.

4. The current collector of claim 1, wherein the polymeric core layer is selected from the group consisting of polyimide (PI), polyethylene terephthalate (PET), polypropylene (PP), polyphenylene sulfide (PPS), polyethylene naphthalate (PEN), or combinations thereof.

5. The current collector of claim 1, wherein the polymeric core layer comprises a smallest dimension of from about 1 μm to about 50 μm, from about 1 μm to about 25 μm, from about 1 μm to about 20 μm, from about 1 μm to about 15 μm, from about 1 μm to about 10 μm, from about 2 μm to about 10 μm, from about 3 μm to about 10 μm, from about 4 μm to about 10 μm, from about 4 μm to about 9 μm, from about 4 μm to about 8 μm, from about 4 μm to about 7 μm, or from about 4 μm to about 6 μm.

6. The current collector of claim 1, wherein the intermediate layers comprise an element selected from the group consisting of Al, Ga, Ge, In, Sn, Sb, Tl, Pb, Bi, or combinations thereof.

7. The current collector of claim 6, wherein the intermediate layers comprise Sn.

8. The current collector of claim 1, wherein each intermediate layer comprises a smallest dimension of from about 1 nm to about 500 nm, from about 1 nm to about 450 nm, from about 1 nm to about 400 nm, from about 1 nm to about 350 nm, from about 1 nm to about 300 nm, from about 1 nm to about 250 nm, from about 1 nm to about 200 nm, from about 2 nm to about 200 nm, from about 3 nm to about 200 nm, from about 4 nm to about 200 nm, from about 5 nm to about 200 nm, from about 5 nm to about 175 nm, from about 5 nm to about 150 nm, from about 5 nm to about 125 nm, from about 5 nm to about 100 nm, from about 5 nm to about 75 nm, from about 6 nm to about 75 nm, from about 7 nm to about 75 nm, from about 8 nm to about 75 nm, from about 9 nm to about 75 nm, from about 10 nm to about 75 nm, from about 10 nm to about 70 nm, from about 10 nm to about 65 nm, from about 10 nm to about 60 nm, from about 10 nm to about 55 nm, from about 10 nm to about 50 nm, from about 10 nm to about 40 nm, or from about 10 nm to about 30 nm.

9. The current collector of claim 1, wherein the conductive metal outer layers comprise Cu.

10. The current collector of claim 1, wherein each conductive metal layer comprises a smallest dimension of from about 0.1 μm to about 5 μm, from about 0.1 μm to about 4 μm, from about 0.1 μm to about 3 μm, from about 0.2 μm to about 3 μm, from about 0.3 μm to about 3 μm, from about 0.4 μm to about 3 μm, from about 0.5 μm to about 3 μm, from about 0.75 μm to about 3 μm, from about 1 μm to about 3 μm, from about 1 μm to about 2.5 μm, from about 1 μm to about 2 μm, or from about 1 μm to about 1.5 μm.

11. (canceled)

12. (canceled)

13. A method for preparing a current collector, the method comprising:
providing a polymeric core layer, wherein the polymeric core layer has oppositely-disposed first and second surfaces;
depositing intermediate layers on the first and second surfaces of the polymeric core layer, wherein each intermediate layer has a front surface attached to the first and/or second surface of the core layer and an oppositely-disposed back surface; and
depositing conductive metal outer layers directly on each back surface of the intermediate layers.

14.-17. (canceled)

18. The method of claim 13, wherein the polymeric core layer is initially provided as a laminated composite comprising the polymeric core layer and a support layer on the first surface of the polymeric core layer, and wherein the method further comprises:
depositing the first intermediate layer and the first conductive metal outer layer on the second surface of the polymeric core layer;
removing the support layer from the first surface of the polymeric core layer; and
depositing the second intermediate layer and the second conductive metal outer layer on the first surface of the polymeric core layer.

19. The method of claim 18, wherein the support layer has a thickness greater than the thickness of the polymeric core layer.

20. A method for attaching an electrical connector to a current collector, the method comprising:
placing the electrical connector on at least a portion of the current collector; and
applying pressure and an elevated temperature to attach the electrical connector to the current collector;
wherein the method is conducted a temperature of from about 75 °C to about 200 °C, from about 75 °C to about 190 °C, from about 75 °C to about 180 °C, from about 75 °C to about 170 °C, from about 75 °C to about 160 °C, from about 75 °C to about 150 °C, from about 80 °C to about 150 °C, from about 85 °C to about 150 °C, from about 90 °C to about 150 °C, from about 95 °C to about 150 °C, from about 100 °C to about 150 °C, from about 100 °C to about 140 °C, from about 100 °C to about 130 °C, or from about 100 °C to about 120 °C; and
wherein the applied pressure is from about 5 psi to about 75 psi, from about 5 psi to about 50 psi, from about 5 psi to about 45 psi, from about 5 psi to about 40 psi, from about 5 psi to about 35 psi, from about 5 psi to about 30 psi, from about 10 psi to about 30 psi, from about 15 psi to about 30 psi, or from about 20 psi to about 30 psi.

21. (canceled)

22. The method of claim 20, wherein the method further comprises placing metal powder between the electrical connector and the current collector prior to applying the pressure at an elevated temperature.

23. The method of claim 22, wherein the metal powder comprises particles of copper, silver, tin, indium, zinc or combinations thereof.

24. The method of claim 22, wherein the metal particles have a size of from about 25 to about 5,000 mesh, from about 25 to about 4,000 mesh, from about 25 to about 3,000 mesh, from about 25 to about 2,000 mesh, from about 25 to about 1,000 mesh, from about 50 to about 1,000 mesh, from about 100 to about 900 mesh, from about 100 to about 800 mesh, from about 100 to about 700 mesh, from about 100 to about 600 mesh, from about 100 to about 500 mesh, from about 200 to about 500 mesh, or from about 300 to about 500 mesh.

25. The method of claim 22, wherein the metal particles are present on the surface of the electrical connector that is placed on at least a portion of the current collector in a concentration of about 20 mg/cm² or less, about 15 mg/cm² or less, about 10 mg/cm² or less, about 5 mg/cm² or less, about 1 mg/cm² or less, about 0.75 mg/cm² or less, about 0.5 mg/cm² or less, or about 0.25 mg/cm² or less.

26. The method of claim 20, wherein the electrical connector comprises aluminum, nickel, copper, tin, zinc, or combinations thereof.

27. (canceled)

28. (canceled)

29. The method of claim 20, wherein the method of attachment of the electrical connector to the current collector achieves an adhesion strength of about 1 N/cm² or greater, about 5 N/cm² or greater, about 10 N/cm² or greater, about 15 N/cm² or greater, about 20 N/cm² or greater, or about 25 N/cm² or greater.
